(19) United States
(12) Patent Application Publication
(10) Pub. No.: US 2026/0167152 A1
(43) Pub. Date: Jun. 18, 2026

(54) CABIN SECURITY SYSTEMS AND METHODS FOR AUTONOMOUS VEHICLES

(71) Applicant: Torc Robotics, Inc., Blacksburg, VA (US)

(72) Inventors: Pablo Smith, Spicewood, TX (US); William Gray Davis, Austin, TX (US); Akshay Pai Raikar, Austin, TX (US); Justin Francis Yurkanin, Austin, TX (US); Mihir Deshingkar, Austin, TX (US); Joseph R. Fox-Rabinovitz, Austin, TX (US)

(21) Appl. No.: 18/980,845

(22) Filed: Dec. 13, 2024

(51) Int. Cl. B60R 25/25; B60R 25/00; B60R 25/01; B60R 25/045; B60W 60/00

(52) U.S. Cl. CPC B60R 25/25; B60R 25/005; B60R 25/008; B60R 25/01; B60R 25/045; B60W 60/00

(57) ABSTRACT

A locking system for an autonomous vehicle, the autonomous vehicle includes a cabin. The locking system includes a first locking system configured to assess access to the cabin, and a second locking system configured to assess access to the use of one or more autonomous vehicle features located in the cabin. The second locking system is engaged with after the first locking system completes the assessment of access to the cabin.

### TECHNICAL FIELD

The field of the disclosure relates to autonomous vehicles and, in particular, to locking systems for autonomous vehicles.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Protection of the autonomous vehicle and the fundamental technologies from unauthorized access is a challenge as the autonomous vehicle is vulnerable without a physical driver being present. An unauthorized user can access the autonomous vehicle with malicious intent to cause physical damage to the vehicle and systems and/or compromise the driving features of the autonomous vehicle. Such actions can be expensive to repair or replace and can create a safety concern to other drivers on the road with the autonomous vehicle.

Accordingly, there exists a need for a system and a method to enable and restrict access into the autonomous vehicle.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a locking system for an autonomous vehicle is provided where the autonomous vehicle includes a cabin. The locking system includes a first locking system configured to assess access to the cabin, and a second locking system configured to assess access to the use of one or more autonomous vehicle features located in the cabin. The second locking system is engaged with after the first locking system completes the assessment of access to the cabin.

In another aspect, a method of accessing one or more features within an interior of a cabin of a vehicle is provided. The method includes engaging with an interior locking system configured to enable use of one or more features of the cabin by inputting a first input. The method includes verifying authorized access to the one or more features of the cabin by communicating with a mission control and comparing the first input against a first input data set. The method includes authorizing access to the one or more features of the cabin in response to acceptance of the first input when compared against the first input data set.

In yet another aspect, a locking system for an autonomous vehicle is provided, where the autonomous vehicle includes a cabin. The locking system includes an interior locking system configured to assess access to the one or more features of the cabin. The interior locking system is in communication with a mission control at least when the access assessment is being completed, wherein the interior locking system is configured to transmit a first input to the mission control for comparison against a first input data set.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIG. 4 is a schematic view of the autonomous truck shown in FIG. 1 with an exterior locking system.

FIG. 5 is a block diagram of the exterior locking system shown in FIG. 4.

FIG. 6 is a schematic view of an interior of the autonomous truck shown in FIG. 4 with an interior locking system.

FIG. 7 is a block diagram of the interior locking system shown in FIG. 6.

FIG. 8 is a block diagram of the exterior locking system shown in FIG. 5 and the interior locking system shown in FIG. 7.

FIG. 9 is a method of interacting with the exterior locking system and the interior locking system of the autonomous vehicle.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA),

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As used herein, a conventional locking system may include, but is not limited to, a keyway lock, a mechanical pushbutton lock, a padlock, a deadbolt, and combinations and variations thereof.

As used herein, an electronic locking system may include, but is not limited to, a keypad, a card reader, an image capturing device, a video capturing device, an RFID reader, and combinations and variations thereof.

As used herein, a biometric locking system may include, but is not limited to, a voice recognition system, a retinal scanner, a fingerprint scanner, an iris scanner, a facial scanner, and combinations and variations thereof.

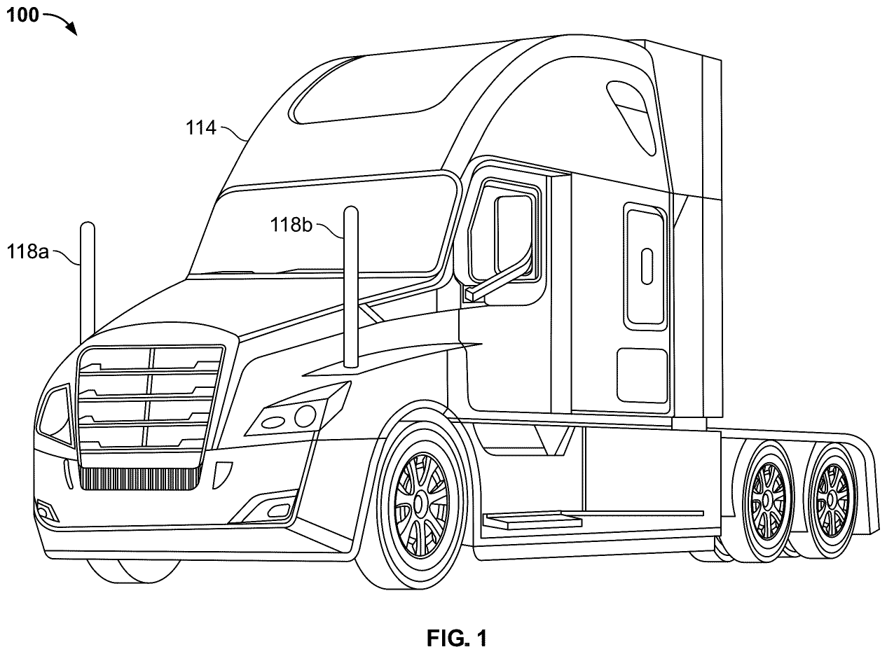

As described herein, the present disclosure is directed to a locking system for a vehicle. Specifically, a locking system that provides a level of user access to an autonomous vehicle cab and operations features based on information analyzed associated with the person trying to gain cab access, and based on the analysis the system either enables access or restricts access to the features of the vehicle. In an exemplary embodiment, the locking system includes an exterior locking system, an interior locking system, or an exterior locking system and an interior locking system. Various embodiments in the present disclosure are described with reference to FIGS. 1-9 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114. The vehicle 100 includes an antenna 118, referenced as a pair of antennas 118A, 118B, which are positioned near the front of the vehicle 100. The pair of antennas 118A, 118B may include one or more sensors.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

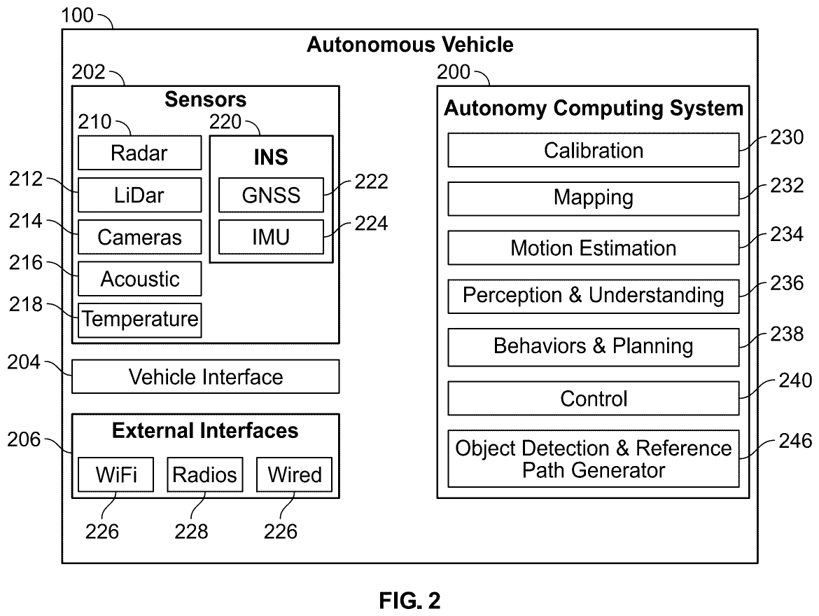

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

In some embodiments, the image data generated by cameras 214 may be transmitted to mission control for one or more of identifying one or more construction markers (or nodes), generating one or more connectivity graphs based upon identified construction markers (or nodes), updating a reference path based upon the one or more connectivity graphs, transmitting the updated reference path to the autonomy vehicle 100 for guiding autonomous vehicle 100 to drive on the updated reference path.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

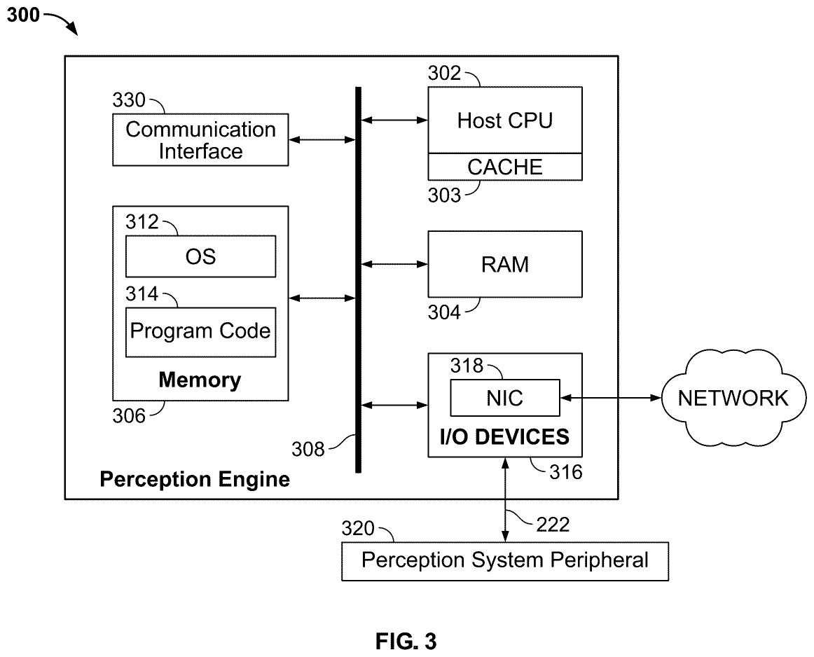

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

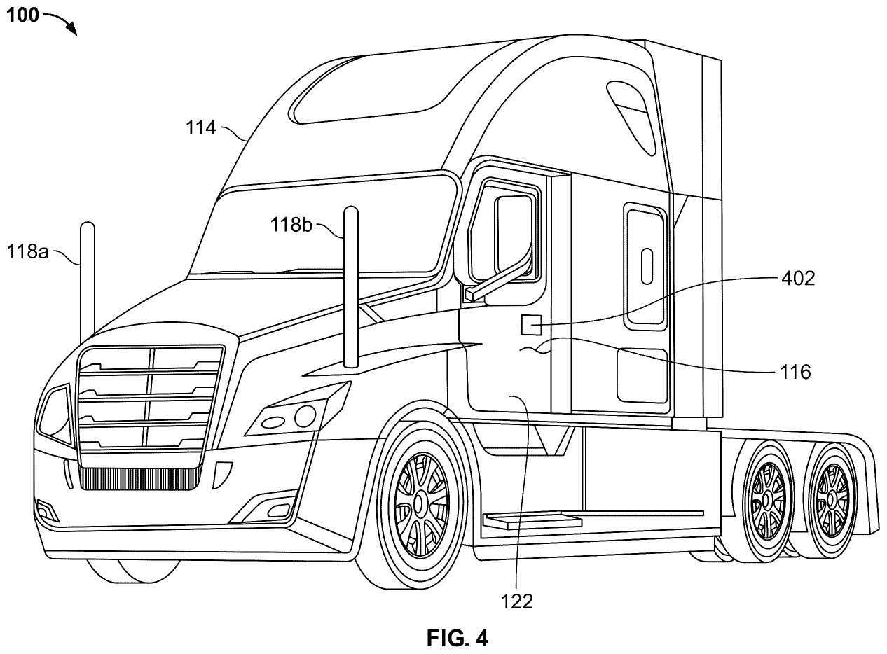

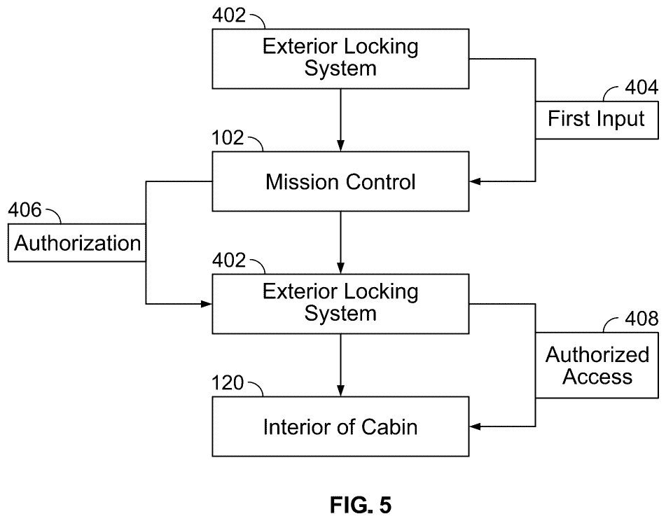

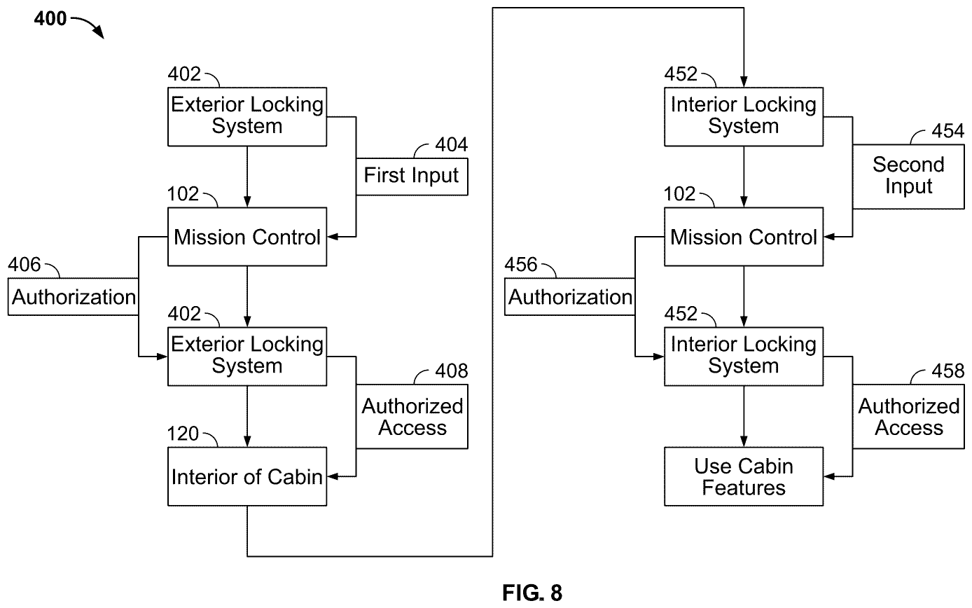

Referring to FIGS. 4-9, the vehicle 100 includes a locking system 400 that is coupled to the cabin 114. The locking system 400 is configured to prevent unauthorized access into the cabin 114 of the vehicle 100, prevent unauthorized access from using one or more features of the vehicle 100, and to prevent unauthorized access into the cabin 114 of the vehicle 100 and prevent an unauthorized user from using one or more features of the vehicle 100. The features may include but are not limited to, starting the vehicle 100, entering commands into computing system 200, and adjusting the sensor 202 functionality. It should be understood that the disclosed system and method is used to generally assess if a person trying to gain access to the cab or adjust vehicle features is authorized to access the cabin and make the desired feature adjustments. Once the access assessment is completed by the system and method, the system and method will either prevent unauthorized access and change to operating features or enable authorized cabin access and feature changes. As the description proceeds, it should be understood that the system and method may be described as being used to prevent access to the cabin or make changes to operation. Unless expressly stated otherwise, any description of the system and method to prevent access to the cabin and features should not be interpreted as limiting the use of the disclosed system and method to only prevent access to the cabin and vehicle operating features. The locking system may include an exterior locking system 402, an interior locking system 452, or the exterior locking system 402 and the interior locking system 452. The exterior locking system 402 and the interior locking system 452 may collectively be referred to as the locking system 400 (see FIG. 8). The locking system 400 may also refer to only the exterior locking system 402 or only the interior locking system 452, unless expressly stated otherwise.

The exterior locking system 402 is accessible from at least an exterior 116 of the cabin 114 and is configured to enable or prevent access to an interior 120 of the cabin 114. The exterior locking system 402 is represented in FIG. 4 as a box on the exterior 116 of the cabin 114. It should be understood, however, that the exterior locking system 402 may define various sizes/shapes, without departing from the spirit/scope of this disclosure. It should also be understood that the exterior locking system 402 may be located at various positions that are accessible from the exterior 116 of the cabin 114, without departing from the spirit/scope of this disclosure. Although depicted as a single exterior locking system 402, the cabin 114 may include two or more exterior locking systems 402. The two or more exterior locking systems 402 may include similarly-designed locking systems 402 or differently-designed locking systems 402, depending on the desired features and/or location. The two or more exterior locking systems 402 may be positioned in proximity to each other coupled to the exterior 116 of the cabin 114 of may be in different locations coupled to the exterior 116 of the cabin 114.

The exterior locking system 402 may be coupled to, either directly or indirectly, one or more access points of the cabin 114. For example, the exterior locking system 402 may be positioned on a door 122 of the cabin 114. The exterior locking system 402 may be positioned on an adjacent exterior cabin surface in proximity to the door 122 of the cabin 114. In some instances, the exterior locking system 402 may be positioned in proximity to a handle (not shown) that is coupled to the door 122 of the cabin 114. In other instances, the exterior locking system 402 may replace or partially replace the handle (not shown).

The exterior locking system 402 may be coupled to the exterior 116 of the cabin 114 for direct engagement by a user. Direct engagement by the user may include, but is not limited to, inserting and/or removing an object from the exterior locking system 402, touching, and/or pressing at least a portion of the exterior locking system 402, sliding and/or engaging an object with the exterior locking system 402, audibly engaging with the exterior locking system 402, biometrically engaging with the exterior locking system 402, and combinations and variations thereof. In a non-limiting example, direct engagement may include waving an RFID card in proximity to the exterior locking system 402. In another non-limiting example, direct engagement may include entering a key code into at least a portion of the exterior locking system 402.

The exterior locking system 402 may be coupled to the exterior 116 of the cabin 114 for indirect engagement by the user. Indirect engagement by the user may include, but is not limited to, positioning the exterior locking system 402 to capture an aspect of the user by utilizing an image capturing device, a video capturing device, an auditory capturing device, a biometric capturing device, and combinations and variations thereof. The exterior locking system 402 may be selected from the group including a conventional locking system, an electronic locking system, a biometric locking system, and combinations thereof for direct and/or indirect engagement by the user.

In a non-limiting example, the exterior locking system 402 may be selected from the group consisting of a retinal scanner, a facial scanner, a finger scanner, voice authentication, password authentication, personal identification number (PIN) authentication, multifactor authentication (MFA) via an app or text messages (SMS or email), a hardware token, a smart card, an iris scanner, a door lock, a deadbolt lock, a key fob lock, a padlock, and combinations thereof. In some instances, one or more features of the exterior locking system 402 may be coupled, either directly or indirectly, with elements of the vehicle 100. For example, the exterior locking system 402 may be part of a central locking system, where locking one door 122 (e.g., driver's door) automatically locks all other doors. The central locking system may be controlled manually, electronically, or partially manually and partially electronically.

In some instances, the exterior locking system 402 may include a GPS-based fleet security system where the vehicle 100 is equipped with a fleet management system that is configured to remotely lock or disable the vehicle's engine or doors through a GPS-linked control center, which may prevent unauthorized access or movement. In other instances, the exterior locking system 402 may include a proximity sensor with passive entry, where when an authorized key fob is within range of the vehicle 100, the vehicle 100 automatically unlocks or locks based on proximity. The locking may be an indirect action initiated by the presence (or absence) of the key fob. In other instances, the exterior locking system 402 may include an electronic cargo locking system, where electronic signals may be used to engage or disengage locks based on input from mission control 102 of the vehicle 100. For example, the vehicle 100 (e.g., a delivery vehicle) may be programmed to lock cargo doors automatically when the vehicle 100 moves or reaches a specific speed, indirectly controlling access. In other instances, the exterior locking system 402 may include a user identification system, where a user's authentication (e.g., biometric, PIN, or card-based access) is required before allowing the vehicle 100 to be unlocked or operated. This indirectly controls vehicle locking by verifying authorized users. In other instances, the exterior locking system 402 may include a time-delay or speed activated locking system, where doors or compartments of the vehicle 100 automatically lock after a specific time delay and/or once the vehicle 100 starts moving, adding an indirect mechanism to ensure the vehicle 100 is secured without manual input.

Referring to FIG. 5, the exterior locking system 402 is in communication with mission control 102. The exterior locking system 402 is configured to send a first input 404 to the mission control 102. The first input 404 may be produced by one or more of the various exterior locking systems 402 outlined herein. The mission control 102 compares or contrasts the first input 404 against a first input data set. It should be understood that the predetermined threshold may include a range or a defined limitation. The defined limitation may include correct/incorrect, yes/no, go/no-go, and variations thereof. For example, the first input 404 may be an identification character (e.g., alphanumeric character). In a non-limiting example, an RFID card (not shown) including the identification character. The RFID card (not shown) interacts with the exterior locking system 402 and the identification character is communicated to the mission control 102. The mission control 102 compares or contrasts the identification character of the RFID card as the first input 404 against the first input data set to determine if the first input 404 is acceptable.

In a non-limiting example, the first input 404 of a retinal scanner is a retinal scan map of the unique blood vessel pattern at the back of the eye of a user. The first input data set of the retinal scanner is the map of the unique blood vessel pattern at the back of the eye of an approved user. In a non-limiting example, the first input 404 of a facial scanner is 2D and/or 3D images of key facial features, such as distance between the eyes, nose width, jawline shape, and combinations and variations thereof, of a user. The first input data set of the facial scanner is the distance between the eyes, nose width, jawline shape, etc. of an approved user.

In a non-limiting example, the first input 404 of a finger scanner is templates and/or images of ridges and valleys of a user fingerprint. The first input data set of the finger scanner are templates and/or images of ridges and valleys of an authorized user's fingerprint. In a non-limiting example, the first input 404 of a voice authentication is voice features, such as pitch, tone, speaking patter, of a user. The first input data set of the voice authentication is voice features, such as pitch, tone, speaking pattern of an authorized user.

In a non-limiting example, the first input 404 of a password authentication is a hash of the stored password of a user. The first input data set of the password authentication is a hash of the stored password of an authorized user. In a non-limiting example, the first input 404 of a PIN authentication is a hash of the stored PIN of a user. The first input data set of the PIN authentication is a hash of the stored PIN of an authorized user.

In a non-limiting example, the first input 404 of a multifactor authentication, a hardware token, and/or a smart card is a code unique to a user, such as a time-based one-time password (TOTP) code or a one-time passcode (OTP), which may be disguised as a secret key, cryptographic key, and/or certificate. The first input data set of the multifactor authentication, the hardware token, and/or the smart code is a TOTP or one-time passcode, which may be disguised as a secret key, cryptographic key, and/or certificate, of an authorized user. In a non-limiting example, the first input 404 of an iris scanner is images of the iris of a user. The first input data set of the iris scanner is images of the iris of an authorized user.

If the first input 404 is within a predetermined threshold provided by the first input data set, then the mission control 102 will provide authorization 406 to the exterior locking system 402 to permit user access the interior 120 of the cabin 114. If the first input 404 is outside of the predetermined threshold provided by the first input data set, then the mission control 102 will instruct the exterior locking system 402 to deny user access, thereby preventing unauthorized access into the interior 120 of the cabin 114. When the mission control 102 provides authorization 406 to the exterior locking system 402, the exterior locking system 402 enables access and/or signals that access is approved 408 into the interior 120 of the cabin 114. Enabling access may include directly unlocking the door 122 of the cabin 114 or sending a signal to unlock the door 122 of the cabin 114. Instances where the mission control 102 has denied access to the interior 120 of the cabin 114, the exterior locking system 402 may reinforce the door 122 and/or signal that access is denied.

Signaling that access is approved or access is denied may include an audible alert (e.g., a chime, a statement/phrase) and/or a visual alert (e.g., a statement/phrase, a symbol). The audible alert may be communicated by the vehicle 100 and/or by a call or message sent to a smartphone device or related device (not shown). The visual alert may be displayed by the vehicle 100 and/or by a message (e.g., email, text message) sent to a smartphone device or related device (not shown). In some instances, a signal may be sent to another user or entity. For example, the signal may be sent to the owner of the vehicle 100, the authorities (e.g., police department), or combinations thereof. The signal may alert the owner of the vehicle 100 and/or the authorities that the cabin 114 of the vehicle is being breached or is attempted to be breached by an unauthorized user, as determined above.

The exterior locking system 402 may reinforce the door 122 to prohibit the unauthorized user from gaining entry to the interior 120 of the cabin 114. The exterior locking system 402 may be coupled to a reinforcement system (not shown), which may include engaging a lock (not shown), and/or engaging members (not shown) that further couple the cabin 114 with the door 122. The members may include hardened metal to function as a deadbolt, similar to the door of a safe/vault. The reinforcement system (not shown) may also include activating a strip of material (not shown) that is positioned in proximity to the door 122 and the cabin 114. The strip of material may be a material that when activated fixedly couples (e.g., welds) the door 122 to the cabin 114. The material may be a thermite material.

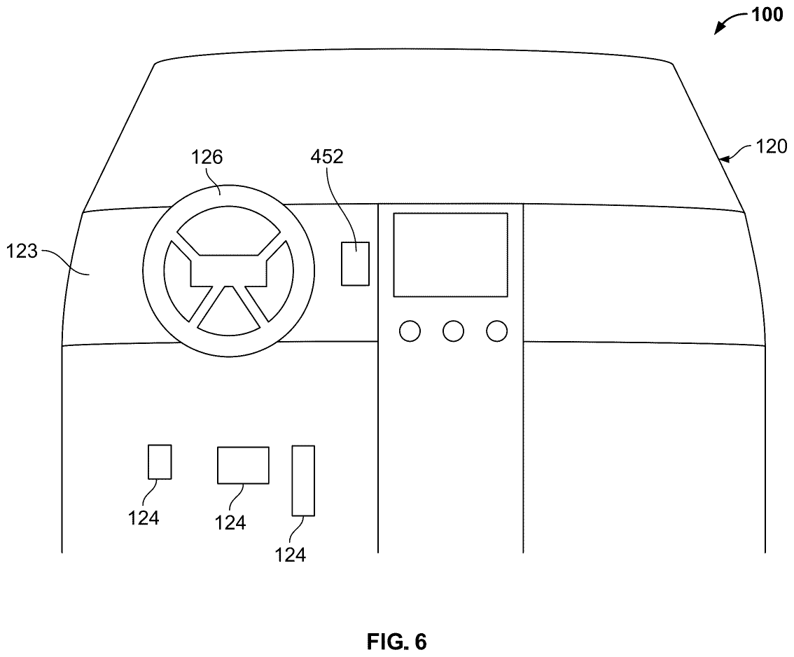

The interior locking system 452 is accessible from at least an interior 120 of the cabin 114 and is configured to enable or prevent use of one or more features of the vehicle 100. The interior locking system 452 is represented in FIG. 6 as a box on a dashboard 123 of the interior 120 of the cabin 114. It should be understood, however, that the interior locking system 452 may define various sizes/shapes and may be located at various positions that are accessible from at least the interior 120 of the cabin 114, without departing from the spirit/scope of this disclosure. The interior locking system 452 may be positioned on one or more pedals 124 (e.g., accelerator, brake, clutch) of the cabin 114. The interior locking system 452 may be positioned on at least a portion of a steering wheel 126.

Although depicted as a single interior locking system 452, the cabin 114 may include two or more interior locking systems 452. The two or more interior locking systems 452 may include similar locking systems 452 or different locking systems 452, depending on the desired features. For example, the interior locking system 452 may be positioned on each pedal 124. The interior locking system 452 may be positioned at two or more locations on the steering wheel 126. For example, in positions that coincide with recommended hand positioning while driving. In some instances, the interior locking system 452 may be positioned on one or more pedals 124 and on the steering wheel 126.

The interior locking system 452 may be coupled to the interior 120 of the cabin 114 for direct engagement by a user. Direct engagement by the user may include, but is not limited to, inserting and/or removing an object from the interior locking system 452, touching, and/or pressing at least a portion of the interior locking system 452, sliding and/or engaging an object with the interior locking system 452, audibly engaging with the interior locking system 452, biometrically engaging with the interior locking system 452, and combinations and variations thereof.

The interior locking system 452 may be coupled to the interior 120 of the cabin 114 for indirect engagement by the user. Indirect engagement by the user may include, but is not limited to, positioning the interior locking system 452 to capture an aspect of the user by utilizing an image capturing device, a video capturing device, an auditory capturing device, a biometric capturing device, and combinations and variations thereof. The interior locking system 452 may be selected from the group including a conventional locking system, an electronic locking system, a biometric locking system, and combinations thereof for direct and/or indirect engagement by the user.

In a non-limiting example, the interior locking system 452 may be selected from the group consisting of a retinal scanner, a facial scanner, a finger scanner, voice authentication, password authentication, personal identification number (PIN) authentication, multifactor authentication (MFA) via an app or text messages (SMS or email), a hardware token, a smart card, an iris scanner, a door lock, a deadbolt lock, a key fob lock, a padlock, and combinations thereof.

In some instances, the interior locking system 452 may replace or supplement a traditional key ignition system (not shown). Therefore, a user may engage with the interior locking system 452 to start the vehicle 100. In addition thereto, the interior locking system 452 may be implemented as described herein. In some embodiments, one or more biometric locking systems may be positioned on the steering wheel 126.

In some instances, the interior locking system 452 may be coupled, either directly or indirectly, to one or more features of the vehicle 100. For example, the interior locking system 452 may be coupled, either directly or indirectly, to the steering wheel 126 or a gearshift (not shown), where the interior locking system 452 prevents the vehicle 100 from being driven and/or shifted into gear. In some instances, the steering wheel/gearshift locking system may be used in combination with one or more previously disclosed interior locking systems 452. In some instances, the interior locking system 452 may include an immobilizer system, where the engine (not shown) of the vehicle 100 is prevented from starting unless the correct key (or key fob with the correct transponder) is present. This indirectly “locks” the vehicle 100 by disabling critical engine components.

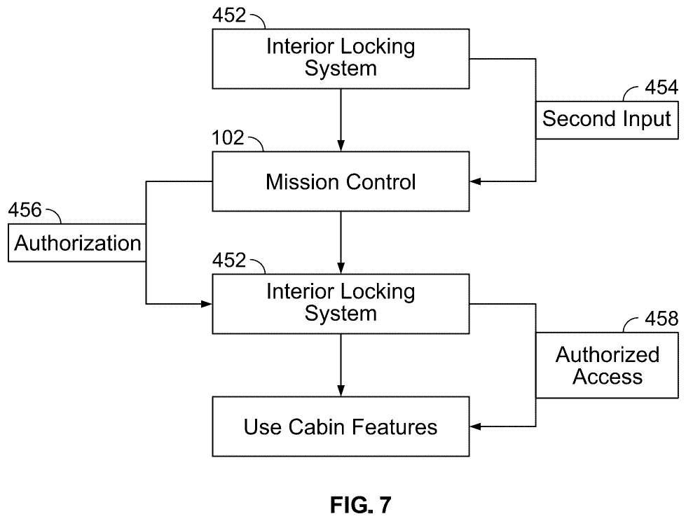

Referring to FIG. 7, the interior locking system 452 is in communication with mission control 102. The interior locking system 452 is configured to send a second input 454 to the mission control 102. The second input 454 may be produced by one or more of the various interior locking system 452 outlined herein. The mission control 102 compares or contrasts the second input 454 against a second input data set. It should be understood that the predetermined threshold may include a range or a defined limitation. The defined limitation may include correct/incorrect, yes/no, go/no-go, and variations thereof. For example, the second input 454 may be an identification character (e.g., alphanumeric character). In a non-limiting example, an RFID card (not shown) including the identification character. The RFID card (not shown) interacts with the interior locking system 452 and the identification character is communicated to the mission control 102. The mission control 102 compares or contrasts the identification character of the RFID card as the second input 454 against the second input data set to determine if the second input 454 is acceptable.

In a non-limiting example, the second input 454 of a retinal scanner is a retinal scan map of the unique blood vessel pattern at the back of the eye of a user. The second input data set of the retinal scanner is the map of the unique blood vessel pattern at the back of the eye of an approved user. In a non-limiting example, the second input 454 of a facial scanner is 2D and/or 3D images of key facial features, such as distance between the eyes, nose width, jawline shape, and combinations and variations thereof, of a user. The second input data set of the facial scanner is the distance between the eyes, nose width, jawline shape, etc. of an approved user.

In a non-limiting example, the second input 454 of a finger scanner is templates and/or images of ridges and valleys of a user fingerprint. The second input data set of the finger scanner are templates and/or images of ridges and valleys of an authorized user's fingerprint. In a non-limiting example, the second input 454 of a voice authentication is voice features, such as pitch, tone, speaking patter, of a user. The second input data set of the voice authentication is voice features, such as pitch, tone, speaking pattern of an authorized user.

In a non-limiting example, the second input 454 of a password authentication is a hash of the stored password of a user. The second input data set of the password authentication is a hash of the stored password of an authorized user. In a non-limiting example, the second input 454 of a PIN authentication is a hash of the stored PIN of a user. The second input data set of the PIN authentication is a hash of the stored PIN of an authorized user.

In a non-limiting example, the second input 454 of a multifactor authentication, a hardware token, and/or a smart card is a code unique to a user, such as a time-based one-time password (TOTP) code or a one-time passcode (OTP), which may be disguised as a secret key, cryptographic key, and/or certificate. The second input data set of the multifactor authentication, the hardware token, and/or the smart code is a TOTP or one-time passcode, which may be disguised as a secret key, cryptographic key, and/or certificate, of an authorized user. In a non-limiting example, the second input 454 of an iris scanner is images of the iris of a user. The second input data set of the iris scanner is images of the iris of an authorized user.

If the second input 454 is within a predetermined threshold provided by the second input data set, then the mission control 102 will provide authorization 456 to the interior locking system 452 to access use one or more features of the cabin 114. If the second input 454 is outside of the predetermined threshold provided by the second input data set, then the mission control 102 will instruct the interior locking system 452 to deny access, thereby preventing unauthorized access to the one or more features of the cabin 114. When the mission control 102 provides authorization 456 to the interior locking system 452, the interior locking system 452 enables access and/or signals that access is approved 458 to use one or more features of the cabin 114. Use of one or more features of the cabin 114 may include communicating with (e.g., read and write) one or more of the mission control 102, autonomy computing system 200, the sensors 202, the vehicle interface 204, and the external interfaces 206. The use of one or more features of the cabin 114 may also include non-autonomous features, such as engaging with the pedals 124 and the steering wheel 126. Instances where the mission control 102 has denied access to use one or more features of the cabin 114, the interior locking system 452 may signal that access is denied.

Signaling that access is approved or access is denied may include an audible alert (e.g., a chime, a statement/phrase) and/or a visual alert (e.g., a statement/phrase, a symbol). The audible alert may be communicated by the vehicle 100 and/or by a call or message sent to a smartphone device or related device (not shown). The visual alert may be displayed by the vehicle 100 and/or by a message (e.g., email, text message) sent to a smartphone device or related device (not shown). In some instances, a signal may be sent to another user or entity. For example, the signal may be sent to the owner of the vehicle 100, the authorities (e.g., police department), or combinations thereof. The signal may alert the owner of the vehicle 100 and/or the authorities that the one or more features of the cabin 114 are being breached or are attempted to be breached by an unauthorized user, as determined above.

In some embodiments, the vehicle 100 may include the exterior locking system 402. In other embodiments, the vehicle 100 may include the interior locking system 452. In exemplary embodiments, the vehicle 100 includes the exterior locking system 402 and the interior locking system 452. The locking system 400, as depicted in FIG. 8, is a block diagram including the exterior locking system 402 and the interior locking system 452. The exterior locking system 402 and the interior locking system 452 are in communication with each other such that the exterior locking system 402 enables access to the cabin 114 of the vehicle and the interior locking system 452 enables access to the features of the vehicle 100.

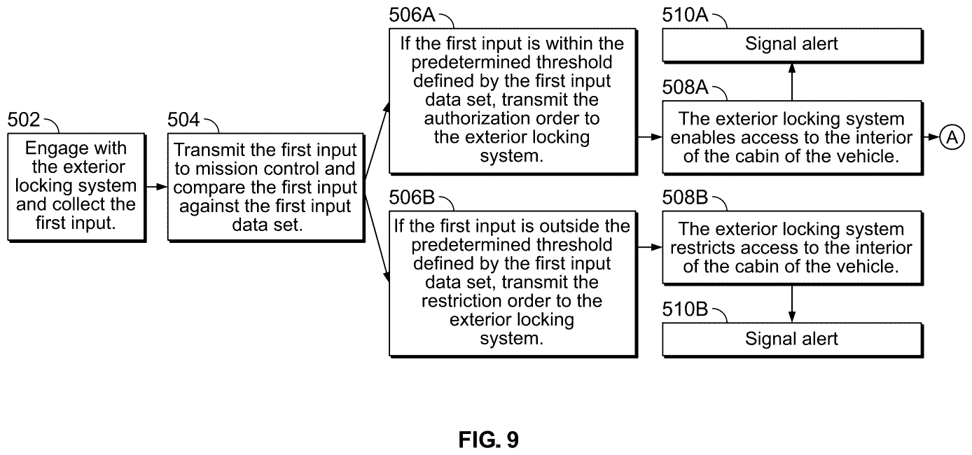

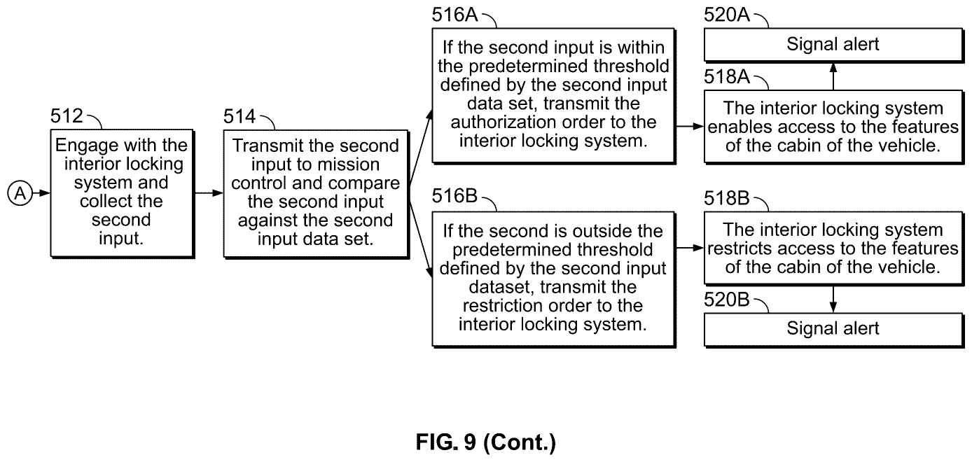

Referring to FIG. 9, a method 500 of communicating with the locking system 400 to first, gain access to the interior 120 of the cabin 114, and second, use the features of the cabin 114. At 502, the user engages with the exterior locking system 402 and the exterior locking system 402 collects the first input 404. At 504, the exterior locking system 402 transmits the first input 404 to the mission control 102, where mission control 102 compares the first input 404 against the first input data set. If the first input 404 is within the predetermined threshold defined by the first input data set, the authorization order 406 is transmitted to the exterior locking system 402, as shown in 506A. Then, at 508A, the exterior locking system 402 enables access 408 to the interior 120 of the cabin 114 of the vehicle 100. A signal alerting the access may be provided, as shown in 510A. If the first input 404 is outside the predetermined threshold defined by the first input data set, the restriction order is transmitted to the exterior locking system 402, as shown in 506B. Then, at 508B, the exterior locking system 402 restricts access to the interior 120 of the cabin 114 of the vehicle 100. A signal alerting the restricted access may be provided, as shown in 510B.

After the user has gained access to the interior 120 of the cabin 114, the user engages with the interior locking system 452 and the interior locking system 452 collects the second input 454, as shown in 512. At 514, the interior locking system 452 transmits the second input 454 to the mission control 102, where mission control 102 compares the second input 454 against the second input data set. If the second input 454 is within the predetermined threshold defined by the second input data set, the authorization order 456 is transmitted to the interior locking system 452, as shown in 516A. Then, at 518A, the interior locking system 452 enables access 458 to the features of the cabin 114 of the vehicle 100. A signal alerting the access may be provided, as shown in 520A. If the second input 454 is outside the predetermined threshold defined by the second input data set, the restriction order is transmitted to the interior locking system 452, as shown in 516B. Then, at 518B, the interior locking system 452 restricts access to the features of the cabin 114 of the vehicle 100. A signal alerting the restricted access may be provided, as shown in 520B.

It should be understood that the operation associated with the exterior locking system 402 and the interior locking system 452 may be implemented individually, without departing from the spirit/scope of this disclosure. In some instances, the mission control 102 may be isolated from the locking system 400. Isolating the mission control 102 from the locking system 400 may ensure a malicious user does not gain access to the mission control 102 or the autonomy computing system 200.

The various aspects illustrated by logical blocks, modules, circuits, processes, algorithms, and algorithms described above may be implemented as electronic hardware, software, or combinations of both. Certain disclosed components, blocks, modules, circuits, are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element recited in the singular and proceeded with the word “a” or “an” should be understood as not excluding plural elements unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A locking system for an autonomous vehicle, the autonomous vehicle including a cabin, the locking system comprising:
a first locking system configured to assess access to the cabin;
a second locking system configured to assess access to the use of one or more autonomous vehicle features located in the cabin;
wherein engagement with the second locking system occurs after the first locking system completes the assessment of access to the cabin.

2. The locking system according to claim 1, wherein the first locking system is accessible from an exterior of the cabin and the second locking system is accessible from an interior of the cabin.

3. The locking system according to claim 1, wherein the first locking system is selected from the group consisting of a conventional locking system, an electronic locking system, a biometric locking system, and combinations thereof.

4. The locking system according to claim 1, wherein the second locking system is selected from the group consisting of a conventional locking system, an electronic locking system, a biometric locking system, and combinations thereof.

5. The locking system according to claim 1, wherein the first locking system is in electrical communication with a mission control, wherein the first locking system is configured to transmit a first input to the mission control for comparison against a first input data set.

6. The locking system according to claim 1, wherein the second locking system is in electrical communication with a mission control, wherein the second locking system is configured to transmit a second input to the mission control for comparison against a second input data set.

7. The locking system according to claim 1, wherein the first locking system is coupled to a door of the cabin.

8. The locking system according to claim 7, wherein the first locking system is coupled to a reinforcement system to limit or exclude access to an interior of the cabin.

9. The locking system according to claim 8, wherein the reinforcement system includes a thermite material to exclude access to the interior of the cabin.

10. A method of accessing one or more features within an interior of a cabin of a vehicle, the method comprising:
engaging with an interior locking system configured to enable use of one or more features of the cabin by inputting a first input;
verifying authorized access to the one or more features of the cabin by communicating with a mission control and comparing the first input against a first input data set; and
authorizing access to the one or more features of the cabin in response to acceptance of the first input when compared against the first input data set.

11. The method according to claim 10, wherein the interior locking system is selected from the group consisting of a conventional locking system, an electronic locking system, a biometric locking system, and combinations thereof.

12. The method according to claim 10 further comprising signaling an alert that access to the one or more features of the cabin has been authorized.

13. The method according to claim 10 further comprising:
engaging with an exterior locking system configured to assess access to the interior of the cabin of the vehicle by inputting a second input;
verifying authorized access to the cabin by communicating with a mission control and comparing the second input against a second input data set; and
authorizing access to the interior of the cabin of the vehicle in response to the second input being within a predetermined threshold provided by the second input data set.

14. The method according to claim 13, wherein the exterior locking system is selected from the group consisting of a conventional locking system, an electronic locking system, a biometric locking system, and combinations thereof.

15. The method according to claim 13 further comprising signaling an alert that access to the cabin has been authorized.

16. The method according to claim 10, further comprising:
engaging with an exterior locking system configured to assess access to the interior of the cabin of the vehicle by inputting a second input;
verifying authorized access to the cabin by communicating with a mission control and comparing the second input against a second input data set; and
restricting access to the interior of the cabin of the vehicle in response to the second input being outside of a predetermined threshold provided by the second input data set.

17. The method according to claim 16 further comprising initiating a reinforcement system to limit or exclude access to the interior of the cabin in response to the second input being outside of the predetermined threshold provided by the second input data set.

18. A locking system for an autonomous vehicle, the autonomous vehicle including a cabin, the locking system comprising:
an interior locking system configured to assess access to the one or more features of the cabin,
wherein the interior locking system is in communication with a mission control at least when the access assessment is being completed, wherein the interior locking system is configured to transmit a first input to the mission control for comparison against a first input data set.

19. The locking system according to claim 18, wherein the interior locking system is positioned in proximity to a steering wheel, an ignition, a pedal, a gearshift, and combinations thereof.

20. The locking system according to claim 18, wherein the interior locking system is selected from the group consisting of a conventional locking system, an electronic locking system, a biometric locking system, and combinations thereof.
